(19) United States
(12) Patent Application Publication
(10) Pub. No.: US 2016/0067655 A1
(43) Pub. Date: Mar. 10, 2016

(54) TAP AND AERATOR APPARATUS

(71) Applicant: Nathaniel Travis Roberts, Costa Mesa, CA (US)

(72) Inventor: Nathaniel Travis Roberts, Costa Mesa, CA (US)

(21) Appl. No.: 14/846,206

(22) Filed: Sep. 4, 2015

Related U.S. Application Data
(60) Provisional application No. 62/048,548, filed on Sep. 10, 2014.
(60) Provisional application No. 62/065,488, filed on Oct. 17, 2014.
(60) Provisional application No. 62/105,962, filed on Jan. 21, 2015.
(60) Provisional application No. 62/201,603, filed on Aug. 6, 2015.

(51) Int. Cl. B01F 3/04; C12G 1/00; B01F 15/02

(52) U.S. Cl. CPC B01F 3/04794; B01F 15/026; C12G 1/00; B01F 3/04815; B01F 2215/0072

(57) ABSTRACT

A tap and aerator apparatus comprising: a container coupling portion; a chamber; one or more aerator portions; a regulator cap; a spout; a valve; and a control member. The container coupling portion is configured to be coupled with a liquid container. The control member is configured to allow the liquid to pass from the container, through the valve, into the chamber, and out of the spout. The regulator cap is configured to be removed from the tap and aerator apparatus to place the aerator portions in an open position. When the aerator portions are opened and when the liquid passes through the chamber, the liquid passing out the spout is aerated by air passing through the one or more aerator portions.

### CROSS-REFERENCE TO RELATED APPLICATIONS

This U.S. Non-Provisional Patent Application claims the benefit of U.S. Provisional Patent Application Nos. 62/048,548, filed on Sep. 10, 2014, titled “Box Wine Tap Aerator Control”, 62/065,488, filed on Oct. 17, 2014, titled “Box Wine Tap Aeration Control Hole Placement”, 62/105,962, filed on Jan. 21, 2015, titled “Tap With Integrated Aerator, Aeration Regulator, And Container Labeling”, and 62/201,603, filed on Aug. 6, 2015, titled “Liquid Dispenser With Integrated Aeration By Cyclone And Regulation Of Aeration”, all by sole inventor Nathaniel Travis Roberts, the contents of which are expressly incorporated herein by this reference as though set forth in their entirety.

### FIELD

The present disclosure relates generally to a tap and aerator apparatus, and more specifically, to a container tap and aerator apparatus with aeration inlets that may be toggled between an open position and a closed position.

### BACKGROUND

The Venturi effect is the phenomenon that occurs when a fluid that is flowing through a tube is forced through a constriction, resulting in a pressure decrease and a velocity increase. Specifically, the fluid must speed up in the constriction in order for the total flow rate to remain the same. However, because the amount of fluid that enters the tube at a certain time must be the same as the amount of fluid coming out, the fluid must move faster through the constriction in order for enough fluid to flow in the specified time. Moreover, because the fluid is flowing faster in the constriction, Bernoulli's principle indicates that the pressure in the constriction should be lower than the pressure outside. Specifically, high pressure before the constriction may cause the fluid to accelerate into the low pressure region of the constriction, and high pressure after the constriction may reduce the speed of the fluid as it exits the constriction. Thus, as fluid is forced through the constriction, the increased flow velocity is accompanied by a pressure drop. Many industry applications, such as wine aerators, utilize this pressure drop to draw air into the fluid.

As most wine enthusiasts know, one of the most common ways to improve the taste of wine immediately before consumption is through aeration. Aeration expands the surface area of wine, thereby allowing air to mingle with the wine. This results with the wine having an expanded aromatic profile. Aerating wine may be performed by utilizing the Venturi effect, which helps pull air into the wine.

A prime candidate for aeration is boxed wine due to its inferior quality compared to bottled wine. Boxed wine is essentially a bag of wine in a box, comprising an integrated tap packaged inside or on the side of the box. Importantly, boxed wine has an open shelf life due to the permeability of the bag, tap, and the rate of consumption of the liquid. In particular, the packaging generally allows small amounts of oxygen into the wine, and this air may eventually cause over oxidation and spoilage to the wine. Although aeration typically enhances wine through oxidation, in some circumstances, such as that of already oxidized wine, it may be a disadvantage to aerate the wine, causing it to become over oxidized.

Due to the large volume of wine in a box of wine, the pressure drop at the valve may be very high. Thus, if a Venturi opening is placed immediately at the narrowest point of the valve, such as is shown in U.S. Published Patent Application No. 2012/0199013, filed by Gutierrez, the Venturi effect may be too strong and the amount of air pulled into the wine may cause the wine to be over-oxidized. Moreover, the spout described in the Gutierrez reference may reduce the flow rate dramatically in order to take direct advantage of the Venturi effect. In some cases, the flow rate may drop as much as 50%. Accordingly, it may take a much longer for a user to pour the appropriate amount of fluid.

Thus, what is needed is a tap apparatus that: (1) provides the proper amount of aeration; (2) has a control to toggle the aeration on and off; and (3) does not significantly impact the flow rate of the primary fluid. The aeration control may be a mechanism that controls the amount of air pulled through to aerate the liquid. The tap apparatus may also provide the ability to inform the consumer when not to use the aerator in order to acquire the best flavor of the liquid.

### SUMMARY

To minimize the limitations in the cited references, and to minimize other limitations that will become apparent upon reading and understanding the present specification, the present specification discloses a new and improved tap and aerator apparatus. The tap apparatus may be a container tap and aerator apparatus, wherein the aeration inlets may be toggled between an open position and a closed position.

One embodiment may be a tap and aerator apparatus comprising: a container coupling portion; a chamber; one or more aerator portions; a regulator cap; a spout; a valve; and a control member. The container coupling portion may be configured to be coupled with a container. The container contains a liquid, which may preferably be wine. The control member may be configured to allow the liquid to pass from the container, through the valve, into the chamber, and out of the spout. The regulator cap may be configured to be removed from the tap and aerator apparatus. When the regulator cap may be removed from the tap and aerator apparatus the one or more aerator portions may be placed in an open position. When the regulator cap is on the apparatus the aerator portions are closed. The aerator portions may be substantially disposed with the chamber and distal to the valve. When the aerator portions may be opened and when the liquid passes through the chamber, the liquid passing out the spout may be aerated by air passing through the one or more aerator portions. The control member may comprise a plunger and an O-ring, wherein the plunger and O-ring may be configured to form a releasable seal with the valve, such that when the control member may be articulated the liquid may be allowed to pass through the valve. The regulator cap may be removeably connected to the tap and aerator apparatus. Alternatively, the regulator cap may be displaceable from the tap and aerator apparatus. The control member may control the flow of the liquid from the container and through the valve. When the regulator cap is not removed the liquid passing through the chamber is not aerated. The tap and aerator apparatus allows a user to aerate and access the liquid with one hand. The air may be drawn through the aerator portions by a vortex force created by the liquid passing through the chamber. The container may include instructions to a user regarding when to remove the regulator cap when pouring the liquid.

Another embodiment may be a tap and aerator apparatus comprising: a container coupling portion; a chamber; one or more aerator portions; a regulator cap; a spout; a valve; a control member. The container coupling portion may be configured to be coupled with a liquid container. The control member may comprise a plunger and an O-ring. The plunger and O-ring may be configured to form a releasable seal with the valve, such that when the control member is articulated the liquid may be allowed to pass from the container, through the valve, into the chamber, and out of the spout. The control member may control the flow of the liquid from the container and through the valve. The regulator cap may be configured to be removed from the tap and aerator apparatus. When the regulator cap is removed from the tap and aerator apparatus the one or more aerator portions may be placed in an open position. The one or more aerator portions may be substantially disposed with the chamber and distal to the valve. When the one or more aerator portions are opened and when the liquid passes through the chamber, the liquid passing out the spout may be aerated by air passing through the one or more aerator portions. The air may be drawn through the aerator portions by a vortex force created by the liquid passing through the chamber. When the regulator cap is not removed the liquid passing through the chamber is not aerated. The tap and aerator apparatus allows a user to aerate and access the liquid with one hand. The regulator cap may be removeably connected to the tap and aerator apparatus via a hinge. The regulator cap may be displaceable from the tap and aerator apparatus. The container includes instructions to a user regarding when to remove the regulator cap when pouring the liquid. The container comprises a box of wine.

It is an object to provide an aerator tap with aerator inlets that may be located at the valve or in the spout.

It is an object to provide an aerator tap with aerator inlets that may be closed or open.

An additional objective is to provide an aerator tap that may be manipulated with a single hand of a user while allowing the aerator inlets to be opened, closed, or in a toggled position. Additionally, the tap apparatus may provide the manufacturer with the ability to inform the consumer when not to use the aerator for obtaining the best flavor of the liquid.

It is an object to overcome the limitations of the prior art.

Other features and advantages will become apparent to those skilled in the art from the following detailed description and its accompanying drawings.

### BRIEF DESCRIPTION OF THE DRAWINGS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is an illustration of a perspective view of one embodiment of a tap and aerator apparatus.

FIG. 2 is an illustration of a front view of one embodiment of a tap and aerator apparatus.

FIG. 3 is an illustration of a side view of one embodiment of the tap and aerator apparatus.

FIG. 4 is an illustration of a cross-section side view of one embodiment of a tap and aerator apparatus.

FIG. 5 is an illustration of a top exploded view of one embodiment of a tap and aerator apparatus.

FIG. 6 is an illustration of a cross-section exploded side view of one embodiment of a tap and aerator apparatus.

FIG. 7 is an illustration of a bottom view of one embodiment of a tap and aerator apparatus.

FIG. 8 is an illustration of one embodiment of a tap and aerator apparatus coupled to a container.

### DETAILED DESCRIPTION OF THE DRAWINGS

In the following detailed description of various embodiments, numerous specific details are set forth in order to provide a thorough understanding of various aspects of the embodiments. However, the embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 1-10% from the indicated number or range of numbers.

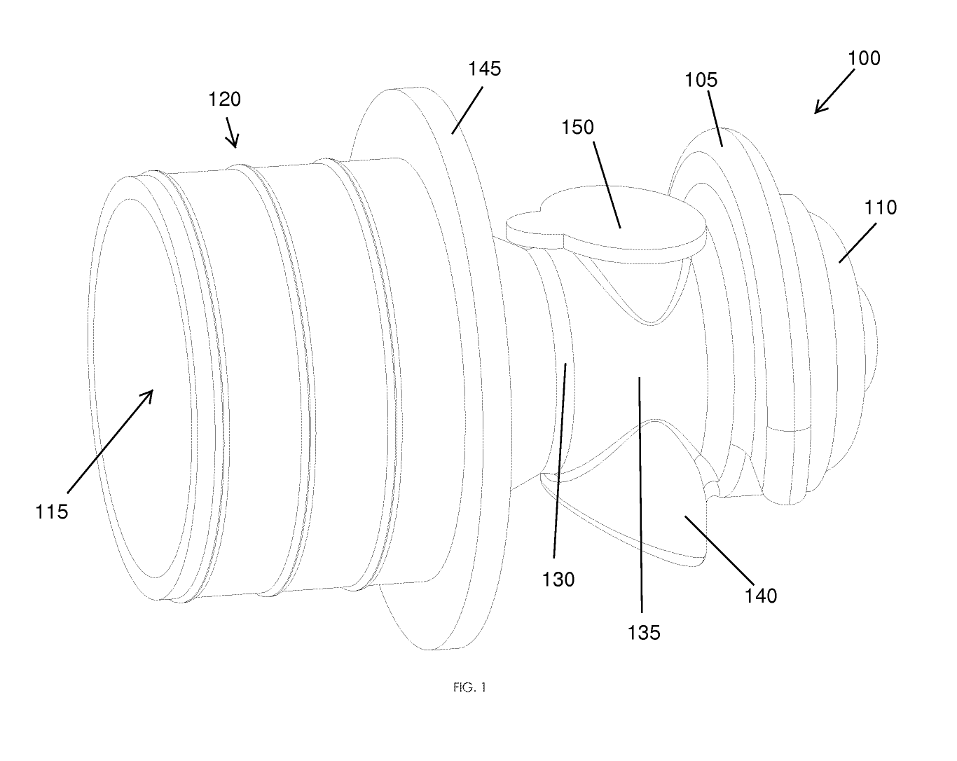

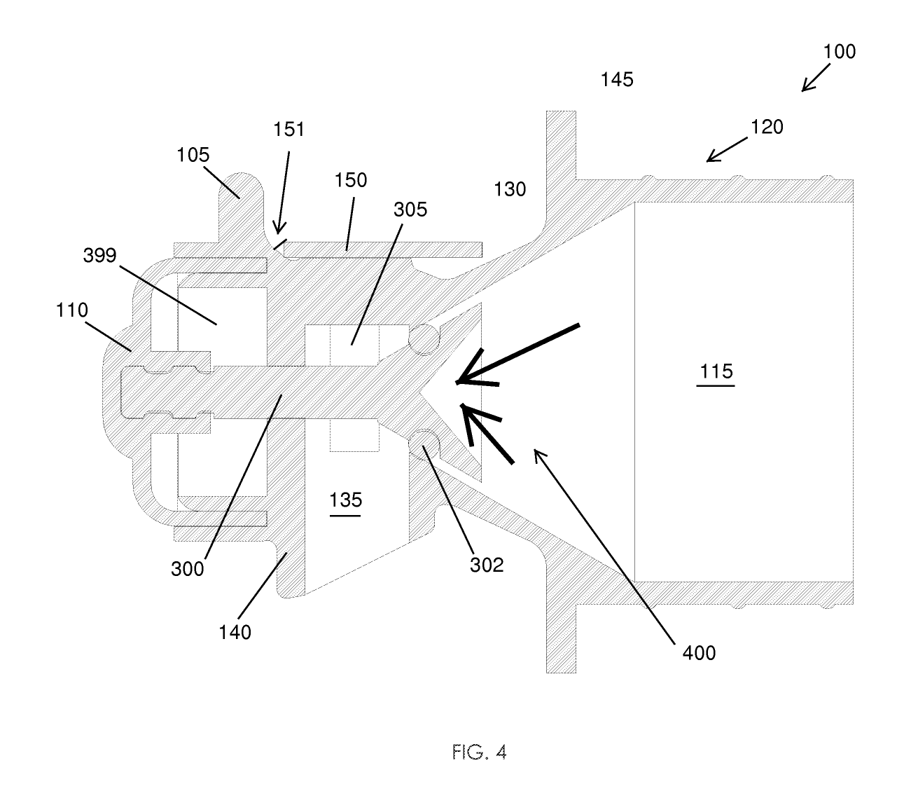

FIG. 1 is an illustration of a perspective view of one embodiment of a tap and aerator apparatus. The tap and aerator apparatus 100 may be coupled with a container in order to assist in the aeration and dispensing of a liquid. The tap and aerator apparatus 100 may be manufactured from any material including, but not limited to, plastic, polymer, resin, thixo, and/or liquid silicone rubber. In one embodiment, the tap and aerator apparatus 100 may be used to serve wine. Thus, the materials of the tap and aerator apparatus 100 may be food grade material. As shown in FIG. 1, the apparatus 100 may comprise a finger grip 105, a control member 110, entry opening 115, container coupling portion 120, valve 130, chamber 135 (shown in FIG. 4), spout 140, coupler ring 145, and a regulator cap 150.

In one embodiment, the tap and aerator apparatus 100 may be configured to couple to a fluid container. Once the tap and aerator apparatus 100 is coupled to the container, a user may initiate with a single hand the flow of liquid from the container and through the tap and aerator apparatus 100 by holding the finger grip 105 and pressing the control member 110. The control member 110 may be designed to dispense liquid from the container such that when a user presses the control member 110, a piston, plunger, rod, and/or other valve actuation mechanism, may be activated, which in turn may release a seal, valve, or closure member. The control member 110 may be constructed as a unitary piece or several parts, as shown herein. Prior to releasing a valve sealing closure member, liquid may be entirely contained within the container and the container coupling portion 120. In one embodiment, the container coupling portion 120 may be substantially housed within the container such that the coupler ring 145 may be substantially flush against the container. In another embodiment, the container coupling portion 120 may removeably connect to a fastener or neck of a container. Once the user releases the valve sealing closure member, the liquid may flow from the container through the tap and aerator apparatus 100, such that liquid travels through the opening 115 of the container coupling portion 120, through the valve 130, into the chamber 135, and out the spout 140. In one embodiment, the spout 140 may be designed to direct the flow of liquid in a downward direction.

The valve 130 may be designed as a narrow section, such that, as liquid passes through, a resulting pressure may decrease and the velocity may increase. Additionally, as shown in FIG. 1, the regulator cap 150, which may cover or house the aerator portions, may be positioned above or directly away from the spout 140. This may allow the aerator portions to provide aeration to the liquid passing through the chamber 135 when the regulator cap is open. Otherwise, the user may prevent aeration by simply closing or sealing the regulator cap 150. The regulator cap 150 may be entirely removeable, removeably connected, and/or displaceable from the tap and aerator apparatus 100. One embodiment, of the regulator cap 150 may be entirely removable, such that the user may remove the regulator cap 150 and set it aside to leave the tap and aerator apparatus 100 in an open position. In this embodiment, however the regulator cap 150 should not be configured to reconnect to the tap and aerator apparatus 100 as in its former position. Another embodiment may be a regulator cap 150 that is removeably connectable, such that the user may remove the cap 150 from the tap and aerator apparatus 100 to open the aerator portions. However, unlike the previous embodiment, the regulator cap 150 may be reconnected to the apparatus 100 to close the aerator portions.

A third embodiment of the regulator cap 150 may be displaceable. In this embodiment, the regulator cap 150 may be partially or completely removed from the tap and aerator apparatus 100 such that the aerator portions are open, but the cap 150 remains attached to the tap and aerator apparatus 100. The cap 150 may remain attached through one or more hinges or slide sides, such that the cap hinges out or pops upward. When the user wants to close the aerator portions, the user flips or pushes the cap 150 downward and reconnects it to the tap and aerator apparatus 100, such that the aerator portions are closed. Alternatively, rather than a hinge, the regulator cap 150 may be tethered to the tap and aerator apparatus 100.

In one embodiment, after the regulator cap 150 has been removed, the aerator portions may be exposed. This may allow the user to close or seal the holes using his or her fingers or other objects. Although FIG. 1 shows that the regulator cap 150 is a form fitting cap, various embodiments of the regulator cap 150 may include, without limitation, a plug, an adhesive strip, a sleeve, a cup, a tab, and/or an insert. The regulator cap 150 may be held firmly or loosely in place via friction, an adhesive, a snap, or one or more removable devices.

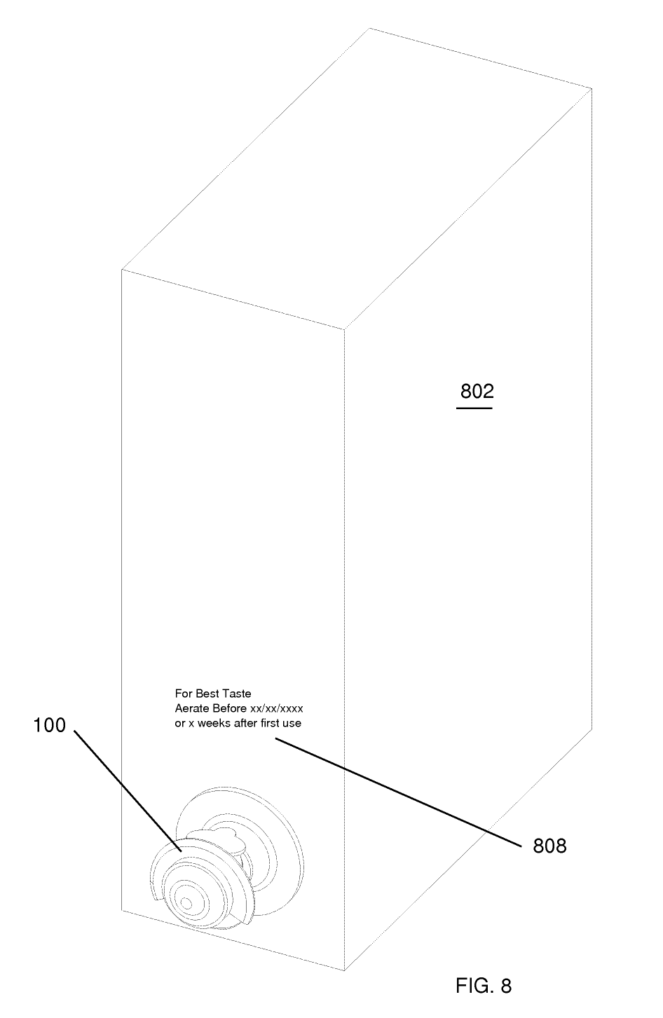

In a preferred embodiment (as shown in FIG. 8), the tap and aerator apparatus 100 may be installed or coupled to a wine box. In this embodiment, the tap and aerator apparatus 100 may release the wine from the wine box in a normal or aerated state. The aeration of the wine will preferably allow the wine to interact with the atmosphere in order to oxidize certain chemicals, such as tannins, naturally contained in the wine, which would otherwise impair the taste of the wine.

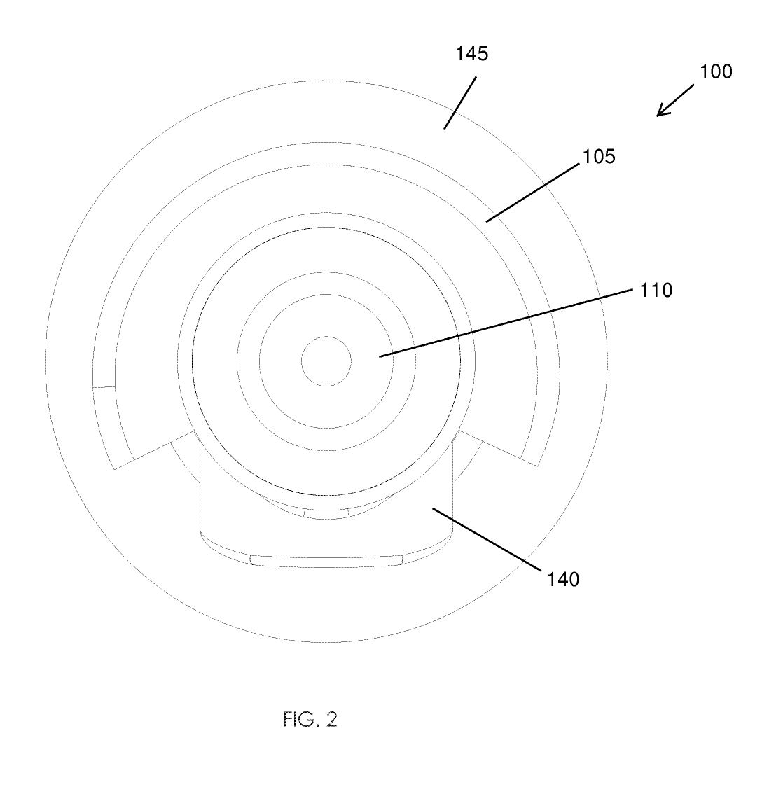

FIG. 2 is an illustration of a front view of one embodiment of a tap and aerator apparatus. FIG. 2 shows that the tap and aerator apparatus may comprise a finger grip 105, control member 110, spout 140, and coupler ring 145. A user may dispense liquid from a container by holding the finger grip 105 and pressing the control member 110 in order to initiate the flow of liquid from the container, through the tap and aerator apparatus 100, and out of the spout 140. In one embodiment, the control member 110, as shown, may be a pressure or spring loaded button that, when depressed, allows liquid to flow into the chamber 135. When released and no longer depressed by the user, the control member 110 may return to its original state. The control member 110 may be any type of mechanism for controlling the flow of a liquid, including, but not limited to, a push button, ball valve lever, pump, a twist valve handle, a lever, a plunger, a pull knob, slide lever, latch, switch, digital switch, and/or a twist knob.

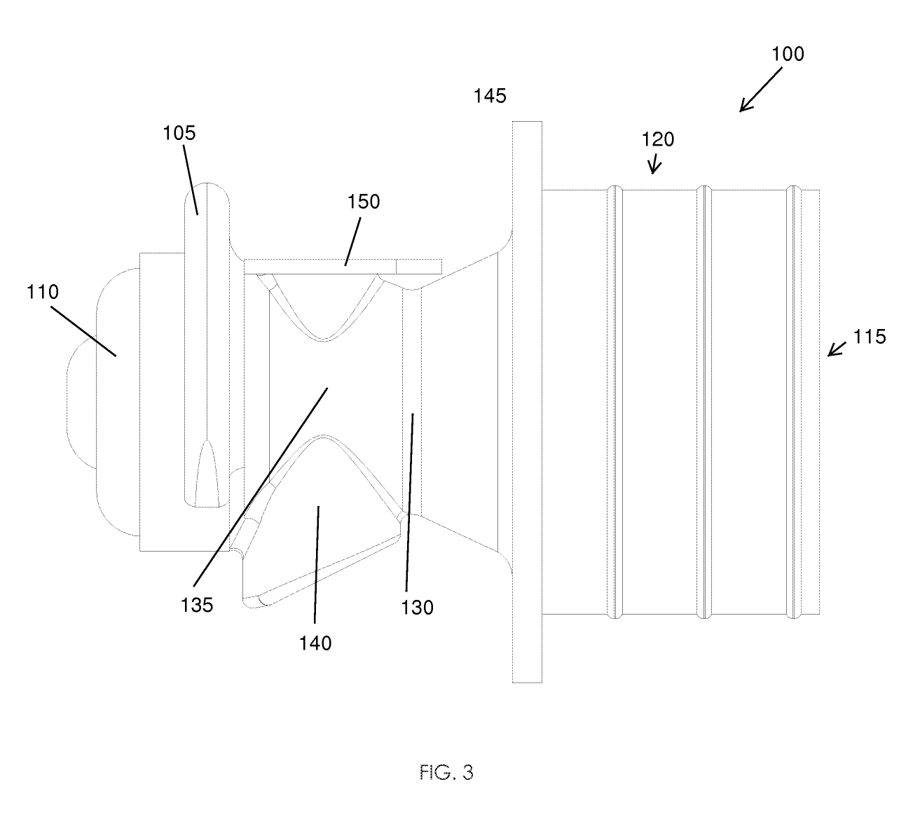

FIG. 3 is an illustration of a side view of one embodiment of the tap and aerator apparatus. As shown in FIG. 3, one embodiment of the tap and aerator apparatus 100 may comprise a finger grip 105, a control member 110, entry opening 115, container coupling portion 120, valve 130, chamber 135, spout 140, coupler ring 145, and a regulator cap 150.

FIG. 4 is an illustration of a cross-section side view of one embodiment of a tap and aerator apparatus. As shown in FIG. 4, one embodiment of the tap and aerator apparatus 100 may comprise: a finger grip 105, a control member 110, entry opening 115, container coupling portion 120, valve 130, chamber 135, spout 140, coupler ring 145, a regulator cap 150, hinge 151, plunger 300, O-ring 302, and aerator portions 305. FIG. 4 shows how the control member 110 may be a button that, when pushed or depressed, forces the plunger 300 inwards such that the fluid pressure 400 is overcome and fluid passes from the entry opening 115, through the valve 130 and into chamber 135. The fluid may then flow out of spout 140. When regulator cap 150 is removed, the fluid in the chamber 135 may create a vortex, cyclone, or suction force that pulls air through the aerator portions 305, which, as shown, may be hollow tubes. In this manner, the liquid being poured is aerated and only aerated if the user chooses to aerate.

When the user stops articulating the control member 110, the fluid pressure 400 causes the plunger 300 to engage with the O-ring 302 to form a seal with the valve 130, thereby obstructing or stopping the flow of liquid out of the container. In an alternative embodiment, the plunger 300 and control member 110, which may be a unitary part or constructed of several different but coupled parts, may be forced towards a closed/outward position via a spring or other mechanical device. This spring may be positioned within the cavity 399 such that the spring forces the plunger 300 and control member 110 outwards. O-ring 302 may be a rubber O-ring, or may be a seal, gasket, or any device that forms a liquid tight and/or air tight seal at or near the valve 130.

In an alternative embodiment, spout 140 may be further constricted or screened at its opening to partially constrict the flow of liquid out of the chamber 135. This alternative embodiment contrasts with preferred embodiment wherein the liquid flow rate from the container is unchanged or only minimally changed with the engagement of the aerator portions 306. Preferably, the chamber 135 and spout 140 are not constricting and do not cause the flow rate to drop when the aerator portions 306 are opened. This preferred embodiment has an open and uninhibited entrance of air that compensates for both flows.

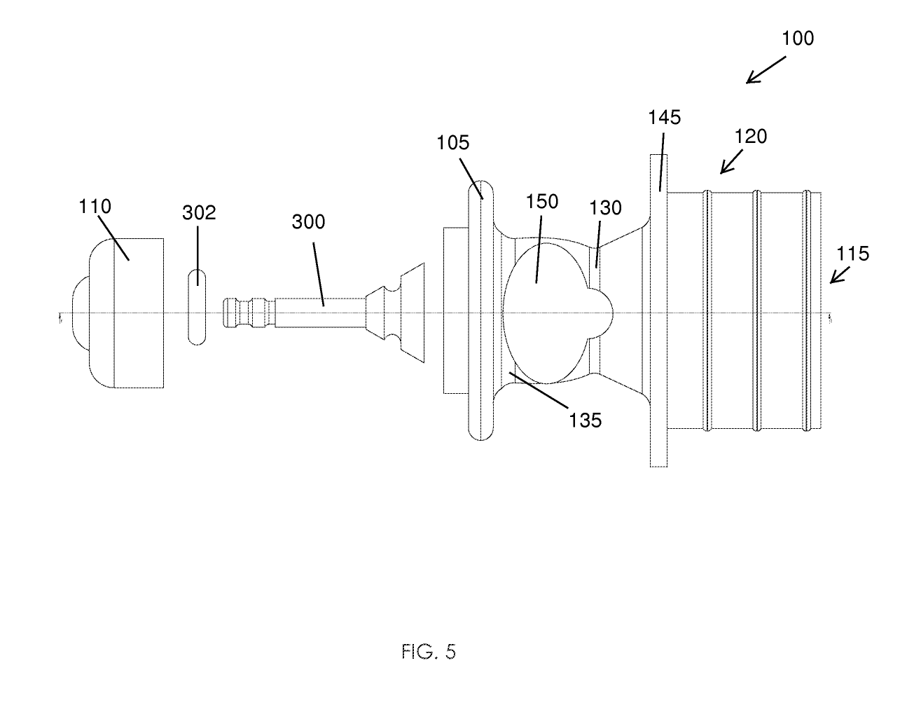

FIG. 5 is an illustration of a top exploded view of one embodiment of a tap and aerator apparatus. As shown in FIG. 4, the apparatus 100 may comprise: a finger grip 105, a control member 110, entry opening 115, container coupling portion 120, valve 130, chamber 135, coupler ring 145, a regulator cap 150, plunger 300, and O-ring 302.

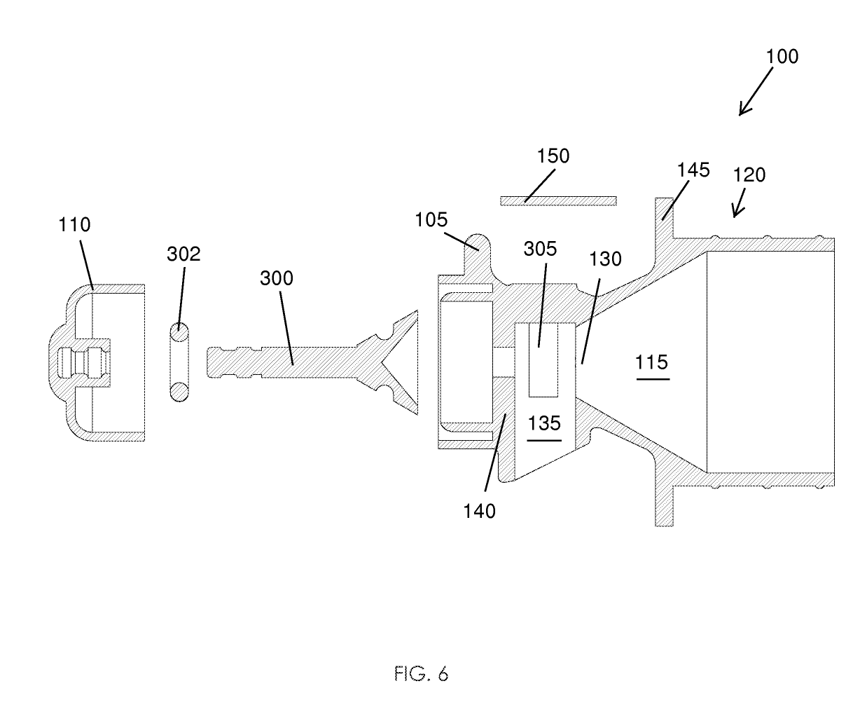

FIG. 6 is an illustration of a cross-section exploded side view of one embodiment of a tap and aerator apparatus. As shown in FIG. 4, one embodiment of the tap and aerator apparatus 100 may comprise: a finger grip 105, a control member 110, entry opening 115, container coupling portion 120, valve 130, chamber 135, spout 140, coupler ring 145, a regulator cap 150, plunger 300, O-ring 302, and aerator portions 305. FIGS. 5 and 6 also show how the parts of the tap and aerator apparatus 100 may engage and fit together.

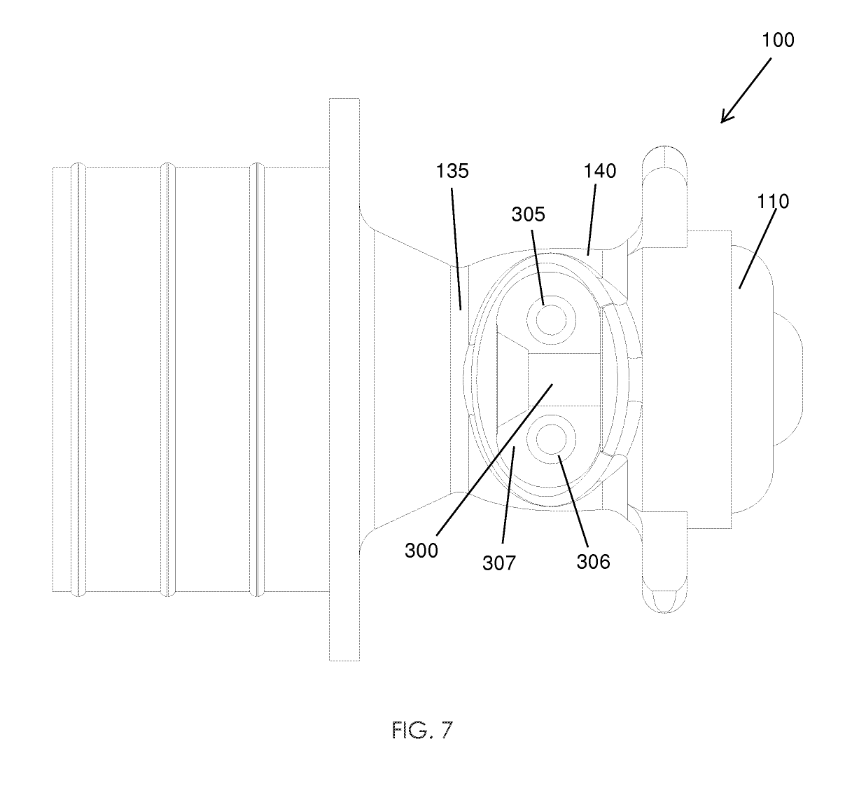

FIG. 7 is an illustration of a bottom view of one embodiment of a tap and aerator apparatus. As shown in FIG. 7, one embodiment of the tap and aerator apparatus 100 may comprise: a chamber 135, spout 140, plunger 300, aerator portions 305, 306, and chamber backing 307. FIG. 7 shows how the control member 110 may be a button that, when pushed or depressed, forces the plunger 300 inward such that the fluid pressure 400 is overcome and the fluid may pass from the entry opening 115, through the valve 130 and into chamber 135. The fluid may then flow out of spout 140. When regulator cap 150 is removed, the fluid in the chamber 135 may create a vortex or suction force that pulls air through the aerator portions 305, 306, which, as shown, may be hollow tubes. Chamber backing 307 may define a top portion of the chamber 135. Although aerator portions 305, 306 are shown substantially perpendicular to valve 130, the aerator portions 305, 306 may be disposed at any angle to enable aeration. Moreover, in some embodiments the aerator portions 305 may be shorter or longer depending upon how much aeration is desired.

In one embodiment the aerator portions 305 may be positioned on or near the valve 130. In this embodiment maximum aeration is desired.

FIG. 8 is an illustration of one embodiment of a tap and aerator apparatus coupled to a container. FIG. 8 shows that the container 802 may be a bag in the box that is configured to hold a fluid, such wine. The bag may be designed to be somewhat air permeable, such that oxygen gas may enter the bag to oxidize the wine. FIG. 8 shows how the tap and aeration apparatus 100 may be coupled to the container 802. Additionally, instructions 808 may be provided to the user to inform him or her the time period of wine consumption. Specification, the instructions 808 may inform the user that the wine is best aerated before a certain date or before/after a certain duration has passed since first accessing the wine. In this manner, the user may be prevented from over oxidizing the wine. FIG. 8 also shows that a user may use a single hand to hold the finger grip 105 and press the control member 110 to initiate the flow of wine from the bag, through the valve 130, into chamber 135, and then out the spout 140.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A tap and aerator apparatus comprising:
a container coupling portion;
a chamber;
one or more aerator portions;
a regulator cap;
a spout;
a valve; and
a control member;
wherein said container coupling portion is configured to couple with a container;
wherein said container contains a liquid;
wherein said control member is attached to said valve and is configured to selectively permit said flow of said liquid from said container, through said valve, into said chamber, and out of said spout;
wherein said regulator cap removeably covers said one or more aerator portions;
wherein, when said regulator cap is removed from said tap and aerator apparatus said one or more aerator portions are placed in an open position;
wherein said one or more aerator portions are substantially disposed with said chamber and distal to said valve; and
wherein when said one or more aerator portions are opened and when said liquid passes through said chamber, said liquid passing out said spout is aerated by air passing through said one or more aerator portions.

2. The tap and aerator apparatus of claim 1, wherein said control member comprises a plunger and an O-ring;
wherein said plunger and O-ring form a releasable seal with said valve, such that when said control member is articulated, said liquid is allowed to pass through said valve.

3. The tap and aerator apparatus of claim 1, wherein said regulator cap is removeably connected to said tap and aerator apparatus.

4. The tap and aerator apparatus of claim 1, wherein said regulator cap is displaceable from said tap and aerator apparatus.

5. The tap and aerator apparatus of claim 1, wherein said control member allows a user to control a flow of said liquid from said container and through said valve.

6. The tap and aerator apparatus of claim 1, wherein when said regulator cap is not removed, said liquid passing through said chamber is not aerated.

7. The tap and aerator apparatus of claim 1, wherein said tap and aerator apparatus allows a user to aerate and access said liquid with a single hand.

8. The tap and aerator apparatus of claim 1, wherein said air is drawn through said aerator portions by a vortex force created by said liquid passing through said chamber.

9. The tap and aerator apparatus of claim 1, further comprising instructions;
wherein said instructions inform a user regarding removing said regulator cap when pouring said liquid.

10. The tap and aerator apparatus of claim 1, wherein when said one or more aerator portions are opened a flow rate of said liquid passing through said chamber is not lowered.

11. The tap and aerator apparatus of claim 1, wherein said container is a box of wine.

12. A tap and aerator apparatus comprising:
a container coupling portion;
a chamber;
one or more aerator portions;
a regulator cap;
a spout;
a valve; and
a control member;
wherein said container coupling portion is configured to couple with a container;
wherein said control member comprises a plunger and an O-ring;
wherein said container contains a liquid;
wherein said plunger and O-ring form a releasable seal with said valve, such that when said control member is articulated, said liquid is allowed to pass from said container, through said valve, into said chamber, and out of said spout;
wherein said control member allows a user to control a flow of said liquid from said container and through said valve;
wherein said regulator cap removeably covers said one or more aerator portions;
wherein, when said regulator cap is removed from said tap and aerator apparatus, said one or more aerator portions are placed in an open position;
wherein said one or more aerator portions are substantially disposed with said chamber and distal to said valve;
wherein when said one or more aerator portions are opened and when said liquid passes through said chamber, said liquid passing out said spout is aerated by air passing through said one or more aerator portions.

13. The tap and aerator apparatus of claim 12, wherein said air is drawn through said aerator portions by a vortex force created by said liquid passing through said chamber.

14. The tap and aerator apparatus of claim 13, wherein, when said regulator cap is not removed, said liquid passing through said chamber is not aerated.

15. The tap and aerator apparatus of claim 14, wherein when said one or more aerator portions are opened a flow rate of said liquid passing through said chamber is not lowered.

16. The tap and aerator apparatus of claim 15, wherein said tap and aerator apparatus allows a user to aerate and access said liquid with a single hand.

17. The tap and aerator apparatus of claim 16, wherein said regulator cap is removeably connected to said tap and aerator apparatus via a hinge.

18. The tap and aerator apparatus of claim 16, wherein said regulator cap is displaceable from said tap and aerator apparatus.

19. The tap and aerator apparatus of claim 16, further comprising instructions; wherein said instructions instruct a user as when to remove said regulator cap when pouring said liquid.

20. The tap and aerator apparatus of claim 19, wherein said container is a box of wine.
